(19) United States
(12) Patent Application Publication
(10) Pub. No.: US 2026/0027964 A1
(43) Pub. Date: Jan. 29, 2026

(54) APPARATUS AND METHOD FOR OUTPUTING A PROJECTION OF A VEHICLE

(71) Applicants: HYUNDAI MOTOR COMPANY, Seoul (KR); KIA CORPORATION, Seoul (KR)

(72) Inventor: Byoung Suk Ahn, Hwaseong-si (KR)

(73) Assignees: HYUNDAI MOTOR COMPANY, Seoul (KR); KIA CORPORATION, Seoul (KR)

(21) Appl. No.: 18/984,237

(22) Filed: Dec. 17, 2024

(30) Foreign Application Priority Data
Jul. 29, 2024 (KR) 10-2024-0100073

(51) Int. Cl. B60Q 1/14; B60Q 1/50; G06V 10/141; G06V 10/30; G06V 10/44; G06V 10/60; G06V 10/75; G06V 20/56

(52) U.S. Cl. CPC B60Q 1/143; B60Q 1/50; G06V 10/141; G06V 10/30; G06V 10/44; G06V 10/60; G06V 10/751; G06V 20/56; B60Q 2400/50

(57) ABSTRACT

An apparatus for outputting a projection of a vehicle includes a control unit configured to convert an image received by an image receiving unit of the vehicle into binary data and to drive a projection output unit of the vehicle to output a projection pattern based on the binary data.

### CROSS-REFERENCE TO RELATED APPLICATION(S)

This application claims benefit of and priority to Korean Patent Application No. 10-2024-0100073, filed on Jul. 29, 2024 in the Korean Intellectual Property Office, the entire contents of which are incorporated herein by reference.

### BACKGROUND

### 1. Field

The present disclosure relates to an apparatus and a method for outputting a projection of a vehicle.

### 2. Description of Related Art

Recently, a device capable of outputting a projection, such as a projection lamp, has been increasingly widely used in a vehicle. Compared to other types of lamps, the projection lamp may emit light distantly with little spread, and thus may effectively provide visual information to a driver or those around the vehicle (for example, other vehicles on a road or a pedestrian). For example, the projection lamp mounted on the vehicle may project an image (and/or message) onto a road surface, and the projected image may have a positive effect on the driver's driving efficiency (e.g., obstacle identification efficiency) or the safety of the vehicle's surroundings (e.g., vehicle recognition speed).

However, such a projection may be partially obscured, distorted, or squashed by a structure surrounding a vehicle, which may lower the projection's ability to provide visual information.

The statements in this section merely provide background information related to the present disclosure and may not constitute prior art.

### SUMMARY

The present disclosure provides an apparatus and a method for outputting a projection of a vehicle that may improve visual information provision performance by outputting a projection pattern adaptive to a structure outside the vehicle.

According to an aspect of the present disclosure, an apparatus for outputting a projection of a vehicle is provided. The apparatus includes: a control unit configured to convert an image received by an image receiving unit of the vehicle into binary data and further configured to drive a projection output unit of the vehicle to output a projection pattern based on the binary data.

According to another aspect of the present disclosure, a method for outputting a projection of a vehicle includes: receiving an image outside the vehicle; converting the received image into binary data; and driving at least one of a light source or an optical system to output a projection pattern based on the converted binary data outward from the vehicle.

According to another aspect of the present disclosure, a non-transitory computer-readable medium includes one or more programs, including instructions, to direct a processor to perform a method of outputting a projection of a vehicle. The method comprises: receiving an image outside the vehicle; converting the received image into binary data; and driving at least one of a light source or an optical system to output a projection pattern based on the converted binary data outward from the vehicle.

### BRIEF DESCRIPTION OF DRAWINGS

The above and other aspects, features, and advantages of the present disclosure should be more clearly understood from the following detailed description, taken in conjunction with the accompanying drawings, in which:

FIGS. 1A and 1B are views illustrating an apparatus for outputting a projection of a vehicle according to an embodiment of the present disclosure;

FIGS. 2A-2C are views illustrating that an image is converted into binary data by the apparatus and the method for outputting a projection of a vehicle according to embodiments of the present disclosure;

FIG. 2D is a view illustrating that a projection pattern is output based on the binary data by the apparatus and the method for outputting a projection of a vehicle according to the embodiments of the present disclosure;

FIGS. 3A and 3B are views illustrating a process of detecting an edge from an image by the apparatus and the method for outputting a projection of a vehicle according to the embodiments of the present disclosure;

FIG. 4 is a view illustrating pixel matching processing performed by the apparatus and the method for outputting a projection of a vehicle according to embodiments of the present disclosure;

FIG. 5A is a view illustrating that a projection output unit is controlled by the apparatus and the method for outputting a projection of a vehicle according to the embodiments of the present disclosure;

FIG. 5B is a view illustrating a method for controlling an optical system of the projection output unit in the apparatus and the method for outputting a projection of a vehicle according to the embodiments of the present disclosure;

FIG. 5C is a view illustrating a method for controlling a light source of the projection output unit in the apparatus and the method for outputting a projection of a vehicle according to the embodiments of the present disclosure;

FIG. 5D is a view illustrating a method for scanning a plurality of pixels of the projection output unit in the apparatus and the method for outputting a projection of a vehicle according to the embodiments of the present disclosure;

FIGS. 6A-6D are views illustrating an on/off period of the projection pattern in the apparatus and the method for outputting a projection of a vehicle according to the embodiments of the present disclosure;

FIG. 7 is a flowchart illustrating a method for outputting a projection of a vehicle according to an embodiment of the present disclosure;

FIGS. 8A and 8B are flowcharts illustrating that the light source is controlled based on illuminance outside the vehicle, and the projection pattern is output in response to a change in whether the door is opened or locked, by the apparatus and the method for outputting a projection of a vehicle according to the embodiments of the present disclosure; and

FIG. 9 is a flowchart illustrating that the projection pattern is output in response to a transmission manipulation and an engine starting manipulation by the apparatus and the method for outputting a projection of a vehicle according to the embodiments of the present disclosure.

The drawings described herein are for illustration purposes only and are not intended to limit the scope of the present disclosure in any way.

### DETAILED DESCRIPTION

The present disclosure may be variously modified and have several embodiments. Therefore, specific exemplary embodiments of the present disclosure are shown in the accompanying drawings and described in detail. However, it should be understood that the present disclosure is not limited to specific embodiments, and includes all modifications, equivalents and substitutions, included in the spirit and scope of the present disclosure.

Terms such as “first” and “second” may be used to describe various components, and the components are not to be interpreted to be limited by the terms. These terms are used only to distinguish one component and another component from each other. For example, a first component may be named a second component and the second component may also be similarly named the first component, without departing from the scope of the present disclosure. A term “and/or” includes a combination of a plurality of related items or any one of the plurality of related items.

Terms used in this specification are used only to describe the specific embodiments rather than limiting the present disclosure. A term of a singular number may include its plural number unless explicitly indicated otherwise in the context. It is to be further understood that the terms such as “comprise,” “include” and the like, used in this specification specify the presence of features, numerals, processes, operations, components, parts mentioned in the specification, or combinations thereof, and do not preclude the presence or addition of one or more other features, numerals, processes, operations, components, parts or combinations thereof. When a component, device, element, or the like of the present disclosure is described as having a purpose or performing an operation, function, or the like, the component, device, or element should be considered herein as being “configured to” meet that purpose or to perform that operation or function.

Unless defined otherwise, it should be understood that all the terms including technical and scientific terms, used herein, have the same meanings as those that are generally understood by those having ordinary skill in the art to which the present disclosure pertains. Terms generally used and defined by a dictionary should be interpreted as having the same meanings as meanings within a context of the related art and should not be interpreted as having ideal or excessively formal meanings unless being clearly defined otherwise in the present specification.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

In the present disclosure, vehicles (including electric vehicles) refer to various types of vehicles that move a transport object such as a person, animal, or an object from a departure point to a destination. The vehicles are not limited to vehicles that travel on a road or a track.

Hereinafter, the embodiments of the present disclosure are described in more detail with reference to the accompanying drawings.

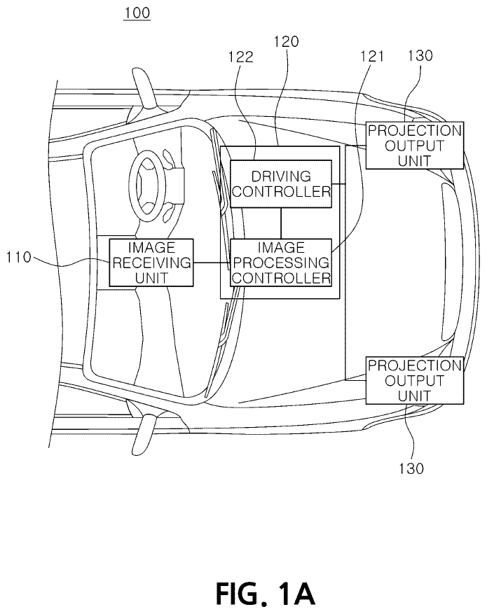

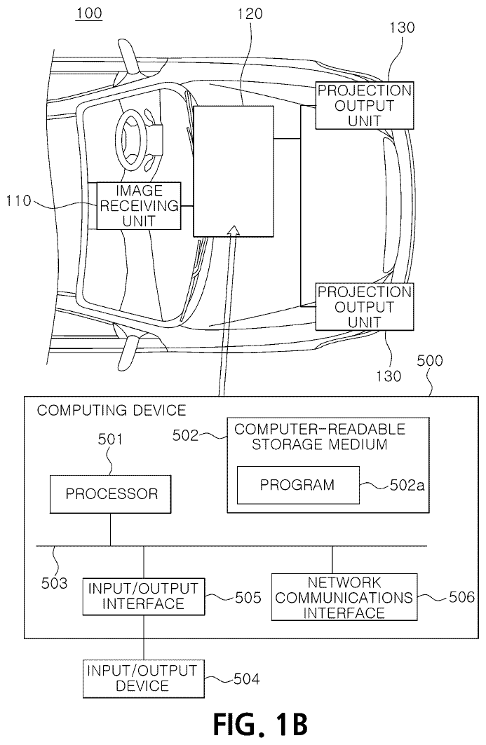

FIGS. 1A and 1B are views illustrating an apparatus for outputting a projection of a vehicle according to an embodiment of the present disclosure. Referring to FIGS. 1A and 1B, according to an embodiment of the present disclosure, an apparatus 100 for outputting a projection of a vehicle may include a control unit 120, an image receiving unit 110 and/or a projection output unit 130.

The image receiving unit 110 may be disposed in the vehicle and receive an image from outside the vehicle. For example, the image receiving unit 110 may collect visual information from the environment outside the vehicle using at least one camera. In other words, the image receiving unit 110 may include at least one camera that captures the outside of the vehicle, and receive the image in a direction opposite to a direction in which the projection output unit 130 outputs a projection pattern (e.g., in front of the vehicle). For example, a capturing range (e.g., field of view) of at least one camera may be adjusted to be close to a projection pattern output range of the projection output unit 130. For example, one or more cameras may be implemented as a plurality of cameras of an autonomous driving system, a plurality of cameras of an around view monitoring system, or a plurality of cameras of a surround view monitoring system. The one or more cameras are not limited to these examples. The image receiving unit 110 may be disposed to be adjacent to the projection output unit 130 or may be implemented to be integrated into the projection output unit 130, based on its design.

The projection output unit 130 may output the projection pattern. The projection pattern output by the projection output unit 130 may indicate a projection that has a specificity level that allows a driver or surroundings of the vehicle (e.g., other vehicles on the road or a pedestrian) to recognize the projection pattern as specific visual information. For example, the projection output unit 130 may include a light source and/or an optical system driven to ensure the sharpness of a boundary (e.g., cut-off line) of the projection pattern to be output. For example, the projection output unit 130 may be implemented as a projection type lamp, disposed in the vehicle as a headlamp, and is not limited thereto.

The control unit 120 may convert the image received by the image receiving unit 110 into binary data, and drive the projection output unit 130 to output the projection pattern based on the binary data. The image received by the image receiving unit 110 may include real-time structural/environmental information outside the vehicle. The binary data may be simplified information of the real-time structural/environmental information. Therefore, the control unit 120 may reflect efficiently the real-time structural/environmental information outside the vehicle in the projection pattern output by the projection output unit 130, and the apparatus 100 for outputting a projection of a vehicle may improve visual information provision performance of the projection by outputting the projection pattern adaptive to a structure outside the vehicle.

For example, recognizing a surrounding object of the image received by the image receiving unit 110 may be implemented by the control unit 120 that converts the image into the binary data. The real-time structural/environmental information outside the vehicle may be variable, and accordingly, the projection pattern based on the binary data that simplifies the real-time structural/environmental information outside the vehicle may also be variable and adaptive. In other words, the projection output unit 130 may output the variable (and/or adaptive) projection pattern.

Referring to FIG. 1A, the control unit 120 may include an image processing controller 121 and/or a driving controller 122. The image processing controller 121 may convert the image received by the image receiving unit 110 into the binary data, and the driving controller 122 may drive the projection output unit 130 to output the projection pattern based on the binary data.

Referring to FIG. 1B, the control unit 120 may be implemented as a computing device 500. For example, the computing device 500 may include a processor 501, a computer-readable storage medium 502, a communications bus 503, an input/output device 504, an input/output interface 505, and a network communications interface 506. The computing device 500 may be implemented as a microcontroller. The computing device 500 may be implemented to perform only predefined operations like an embedded system, based on its design.

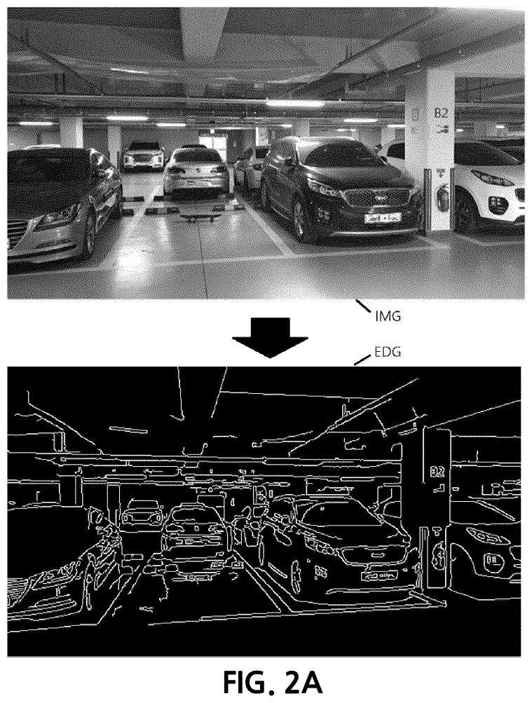

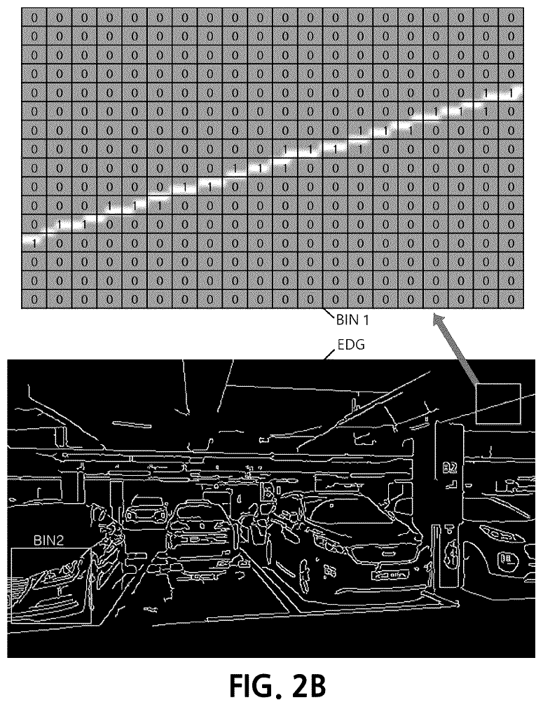

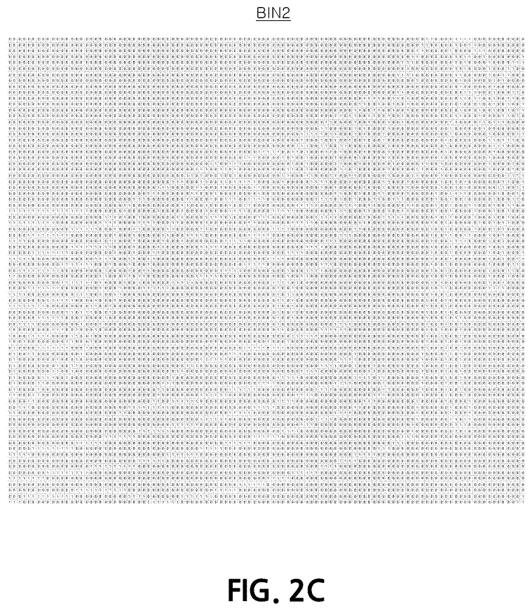

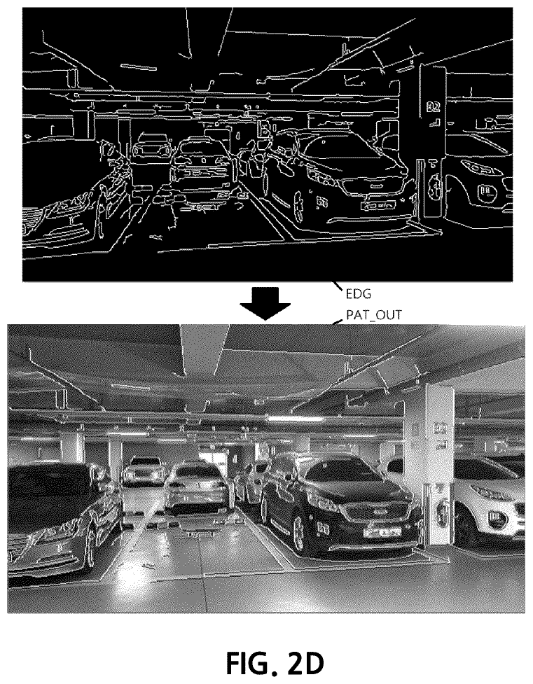

FIGS. 2A, 2B and 2C are views illustrating that the image is converted into the binary data by the apparatus and the method for outputting a projection of a vehicle according to the embodiments of the present disclosure; and FIG. 2D is a view illustrating that the projection pattern is output based on the binary data by the apparatus and the method for outputting a projection of a vehicle according to the embodiments of the present disclosure.

Referring to FIGS. 1A through 2D, the control unit 120 may detect binary data EDG from an image IMG received by the image receiving unit 110, and parts BIN1 and BIN2 of the binary data EDG may consist of 0 and 1. The control unit 120 may output a projection pattern PAT_OUT based on the binary data EDG.

The binary data may include the binary data (consisting of 0 or 1) of each of the plurality of pixels in a matrix, and the control unit 120 may drive the projection output unit 130 to output the projection pattern PAT_OUT, whose switching-on/off is determined in response to the binary data (consisting of 0 or 1) of each of the plurality of pixels. The matrix may indicate a structure where the binary data (consisting of 0 or 1) are arranged in two-dimensional units of equal distance, the rows and columns of the matrix may be perpendicular to each other, one of the rows and columns may be disposed in a vertical direction, and the other of the rows and columns may be disposed in a horizontal direction.

The image captured by the camera of the image receiving unit 110 may also include the plurality of pixels in the matrix structure. Therefore, the image processing controller 121 of the control unit 120 may generate the plurality of pixels whose binary values are determined based on a pixel value (e.g., brightness, luminance, saturation) of each of the plurality of pixels in the image, thereby generating the binary data (consisting of 0 or 1).

For example, the control unit 120 may detect an edge based on a change in the pixel value of each of the plurality of pixels in the image received by the image receiving unit 110, and generate the binary data based on the edge. For example, the change in the pixel value may be implemented as a spatial frequency of each of the plurality of pixels, and the image processing controller 121 of the control unit 120 may generate a spatial frequency value of each of the plurality of pixels by performing a discrete Fourier transform or a discrete cosine transform on the image.

For example, a difference in the pixel values on both sides of a boundary of each object in the image may be large, and a difference in the spatial frequency between the boundary of each object in the image and its remaining part may be large. The control unit 120 may detect a group of pixels whose spatial frequency falls within a specific range as the edge.

Referring to FIG. 1A and FIG. 2D, the control unit 120 may drive the projection output unit 130 to output the projection pattern PAT_OUT, which is determined for one of the pixels corresponding to the edge and the pixels not corresponding to the edge to be switched on and the other to be switched off. The switching on and off may correspond to 1 and 0 of the binary data, and the driving controller 122 of the control unit 120 may thus determine whether to emit light to each of the plurality of pixels in the projection pattern output range of the projection output unit 130 in response to the binary data, and drive the projection output unit 130 based on the determination of whether to emit light.

For example, the projection output unit 130 may emit light having strong rectilinearity at a position corresponding to a group of pixels which are switched on among the plurality of pixels, and may not emit light at a position corresponding to a group of pixels which are switched off among the plurality of pixels. Accordingly, the control unit 120 may drive the projection output unit 130 to output the projection pattern PAT_OUT having the same shape as at least a portion of the edge.

The image received by the image receiving unit 110 may include the real-time structural/environmental information outside the vehicle, the edge may correspond to the real-time structural/environmental information outside the vehicle, and the edge may thus be variable (and/or adaptive). The edge may be variable (and/or adaptive), and accordingly, the projection pattern PAT_OUT, which has the same shape as at least a portion of the edge, may also be variable (and/or adaptive). For example, the projection pattern PAT_OUT, which is variable (and/or adaptive), may be implemented to be similar to an animation. Therefore, the control unit 120 may drive the projection output unit 130 as if the control unit 120 were replaying the animation through the projection output unit 130.

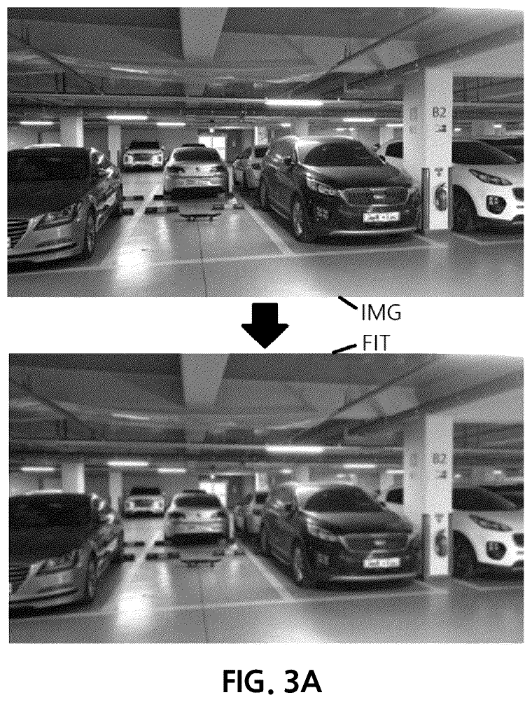

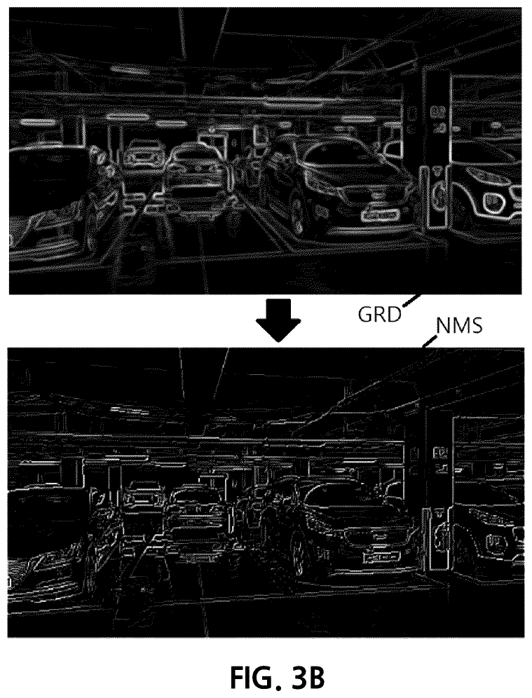

FIGS. 3A and 3B are views illustrating a process of detecting the edge from the image by the apparatus and the method for outputting a projection of a vehicle according to the embodiments of the present disclosure.

Referring to FIGS. 1A and 3A, the control unit 120 may generate an image FIT from which noise is removed from the image IMG. For example, the image processing controller 121 of the control unit 120 may generate the image FIT from which noise is removed by applying a filter such as Gaussian Blur to the image IMG.

Referring to FIGS. 1A, 3A, and 3B, the control unit 120 may generate a gradient GRD by calculating the change in the pixel value from the image FIT from which noise is removed. For example, the image processing controller 121 of the control unit 120 may generate the gradient GRD by applying an edge detection filter (e.g., Sobel filter or Roberts filter) to the image FIT from which noise is removed.

Referring to FIGS. 1A and 3B, the control unit 120 may detect a strong edge NMS based on the gradient GRD corresponding to the change in the pixel value. For example, the strong edge NMS may include distinct boundary pixels. The control unit 120 may detect an edge candidate that is weaker than the strong edge NMS, detect a weak edge that extends from the strong edge NMS among the weak edge candidates, and generate the binary data EDG (in FIG. 2A) based on the strong edge NMS and the weak edge.

For example, the image processing controller 121 of the control unit 120 may detect the strong edge NMS by applying normalization or non-maximum suppression to the gradient GRD.

For example, the image processing controller 121 of the control unit 120 may generate the gradient GRD based on a magnitude relationship between the change in the pixel value and a first threshold value, and may detect the strong edge NMS based on a magnitude relationship between the change in the pixel value and a second threshold value. A combination of the first threshold value and the second threshold value may be defined as a double threshold.

The sharpness of the strong edge NMS (e.g., the width and length of the edge) may be higher than that of the weak edge, and the strong edge NMS may thus have a higher fitness for the real-time structural/environmental information included in the image. The weak edge may have a lower fitness for the real-time structural/environmental information included in the image. Therefore, the control unit 120 may first detect the weak edge candidate, select some of the weak edge candidates that have good connectivity to the strong edge NMS, and exclude the remaining candidates, thereby increasing the fitness of the edge for weak the real-time structural/environmental information.

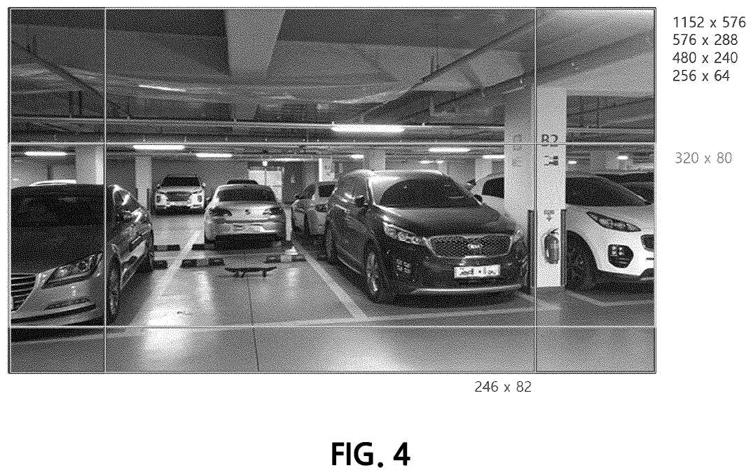

FIG. 4 is a view illustrating pixel matching processing performed by the apparatus and the method for outputting a projection of a vehicle according to embodiments of the present disclosure. Referring to FIGS. 1A and 4, the control unit 120 may perform the pixel matching processing between the plurality of pixels in the image received by the image receiving unit 110 and the plurality of pixels in the binary data.

For example, the plurality of pixels in the binary data may correspond to the plurality of pixels in a projection output range of the projection output unit 130, and thus be determined based on a specification of the projection output unit 130. On the other hand, the plurality of pixels in the image received by the image receiving unit 110 may be determined based on a specification of the camera of the image receiving unit 110. A specification of the image receiving unit 110 and the specification of the projection output unit 130 may not match each other, and the control unit 120 may match the specification of the image receiving unit 110 and the specification of the projection output unit 130 through the pixel matching processing.

For example, the plurality of pixels in the projection output range of the projection output unit 130 may include one of a 1152×576 structure, a 576×288 structure, a 480×240 structure, a 256×64 structure, a 320×80 structure, and a 246×82 structure. For example, an aspect ratio of the 1152×576 structure, the 576×288 structure, the 480×240 structure, or the 256×64 structure may be the same as each aspect ratio of the plurality of pixels in the image. However, an aspect ratio of the 320×80 structure may be higher than each aspect ratio of the plurality of pixels in the image, and an aspect ratio of the 246×82 structure may be lower than each aspect ratio of the plurality of pixels in the image. The control unit 120 may perform the pixel matching processing by matching the aspect ratio of the projection output range of the projection output unit 130 and the aspect ratio of the image.

Alternatively, the resolutions of the 1152×576 structure, the 576×288 structure, the 480×240 structure, and the 256×64 structure may be different from each other, and different from the resolution of the image. Therefore, the control unit 120 may perform the pixel matching processing by matching the resolution of the projection output range of the projection output unit 130 and the resolution of the image. For example, the resolution change and the aspect ratio change may be implemented by merging the adjacent pixels or approximating the pixel values.

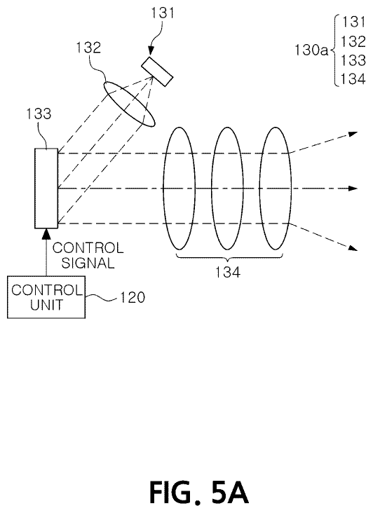

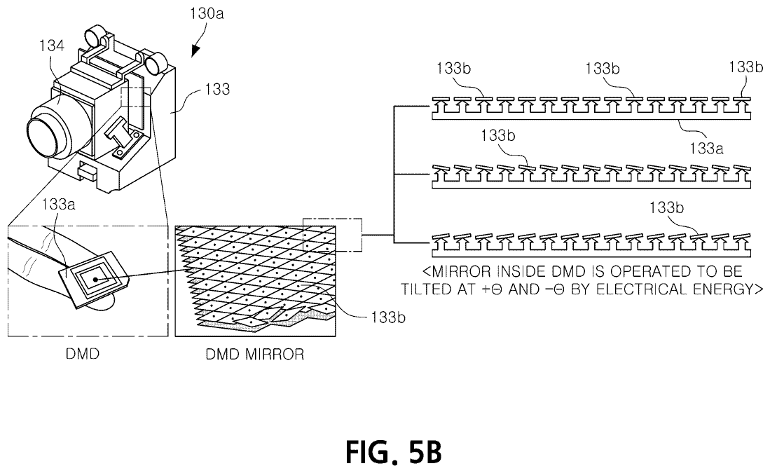

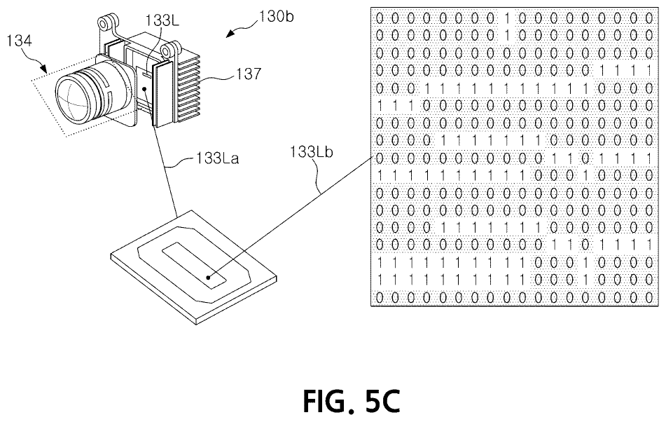

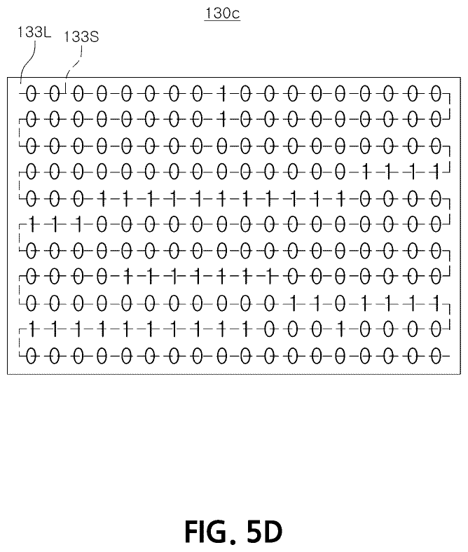

FIG. 5A is a view illustrating that the projection output unit is controlled by the apparatus and the method for outputting a projection of a vehicle according to the embodiments of the present disclosure; FIG. 5B is a view illustrating a method for controlling the optical system of the projection output unit in the apparatus and the method for outputting a projection of a vehicle according to the embodiments of the present disclosure; FIG. 5C is a view illustrating a method for controlling the light source of the projection output unit in the apparatus and the method for outputting a projection of a vehicle according to the embodiments of the present disclosure; and FIG. 5D is a view illustrating a method for scanning the plurality of pixels of the projection output unit in the apparatus and the method for outputting a projection of a vehicle according to the embodiments of the present disclosure.

Referring to FIGS. 5A and 5B, a projection output unit 130a may include at least one of a light source 131 and the optical system, and the control unit 120 may control switching on/off of at least one of the light source 131 and the optical system in response to the binary data of each of the plurality of pixels. For example, the optical system may include at least one of a focusing lens 132, a variable mirror 133, and an imaging lens 134.

For example, the light source 131 may emit light, and the variable mirror 133 may reflect light emitted by the light source 131 and reflect light in a different direction through each reflection area because the reflection area is divided. The imaging lens 134 may receive light reflected from the variable mirror 133 and project the same to the projection pattern output range (e.g., road surface).

For example, the light source 131 may include a light emitting diode and may be installed to emit light to the variable mirror 133. The focusing lens 132 may be disposed between the light source 131 and the variable mirror 133 for light emitted by the light source 131 to be incident on the variable mirror 133.

The variable mirror 133 may include a number of micro-reflectors that are switched on and off based on the input of a control signal from the control unit 120 to thus change their angles, thereby changing a movement direction of incident light. For example, the variable mirror 133 may include a digital micro-mirror device (DMD), and change the movement direction of incident light by adjusting the angle of the micro reflector by switching on/off control.

The plurality of imaging lenses 134 may be provided, and light passing through the imaging lenses 134 may be projected based on a specific angular arrangement.

For example, the variable mirror 133 of the optical system that may be implemented as the DMD may include a variable mirror substrate 133a and a variable mirror array structure 133b. The control unit 120 may generate the control signal (electrical energy) to control a tilt angle (e.g., +θ or −θ) of each of the plurality of pixels in the variable mirror array structure 133b, and control the tilt angle of the variable mirror array structure 133b by using the variable mirror substrate 133a. For example, the control unit 120 may transmit the control signal to the variable mirror 133 of the optical system through wired or wireless communications.

For example, some of the plurality of pixels in the variable mirror array structure 133b may be controlled at an angle to reflect light received from the light source 131 toward the imaging lens 134, correspond to 1 of the binary data, and correspond to the projection pattern output by the projection output unit 130a. For example, the remaining pixels of the plurality of pixels in the variable mirror array structure 133b may be controlled at an angle to reflect light received from the light source 131 in a direction different from the direction toward the imaging lens 134, and correspond to 0 of the binary data.

Referring to FIGS. 1A and 5C, a projection output unit 130b may include a light source 133L. The light source 133L may include a light source substrate 133La and a light source array structure 133Lb. For example, the control unit 120 may generate the control signal to control the switching on/off of each of the plurality of pixels in the light source array structure 133Lb, and may control the switching on/off of the light source array structure 133Lb by using the light source substrate 133La. For example, the control unit 120 may transmit the control signal to the light source 133L of the optical system through the wired or wireless communications. For example, the pixels which are switched on among the plurality of pixels in the light source array structure 133Lb may correspond to 1 of the binary data, and the pixels which are switched off among the plurality of pixels of the light source array structure 133Lb may correspond to 0 of the binary data.

For example, the projection output unit 130b may include the imaging lens 134 and/or a heat dissipation structure 137, and the heat dissipation structure 137 may efficiently dissipate heat generated by the light source 133L outward from the projection output unit 130b. For example, the light source array structure 133Lb may include a plurality of light emitting diode chips corresponding to the plurality of pixels.

Referring to FIGS. 1A and 5D, a projection output unit 130c may include a scanner 133S outputting the projection pattern by sequentially scanning the plurality of pixels in the light source 133L. For example, the scanner 133S may be implemented to be moved or tilted slightly by a micro electro mechanical system (MEMS) technology, and implement the projection pattern from the plurality of pixels in the light source 133L based on the slight movement or tilt. For example, the light source 133L may be implemented as a laser output device and/or a phosphor, and the scanner 133S may include a piezoelectric element (e.g., piezoelectric actuator). A period in which the scanner 133S scans all the plurality of pixels once may correspond to one output period of the projection pattern of the projection output unit 130c. The light source 133L may be replaced with the variable mirror 133 of FIG. 5A based on its design.

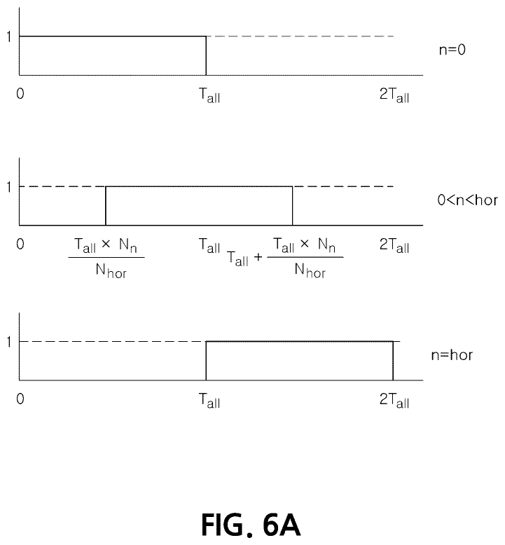

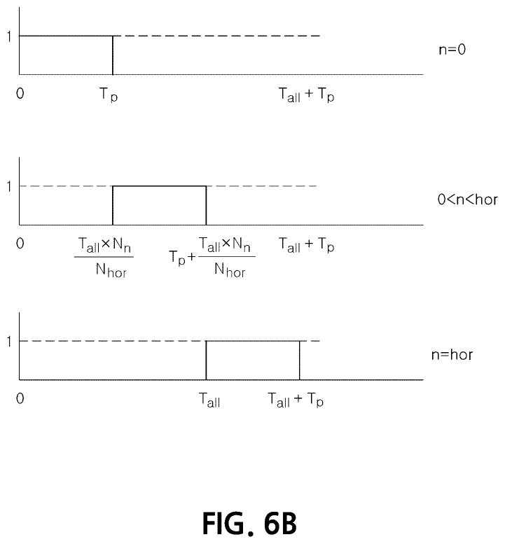

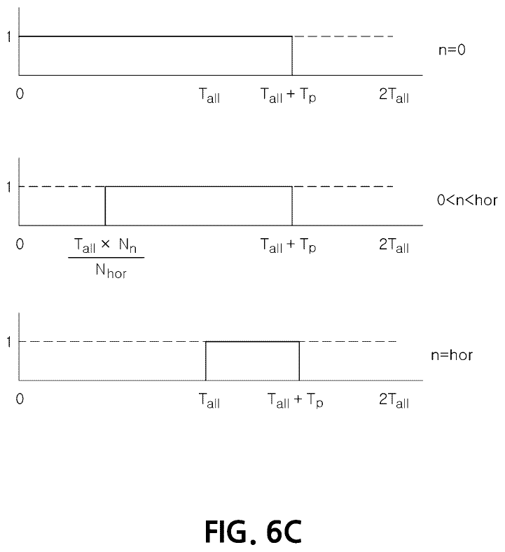

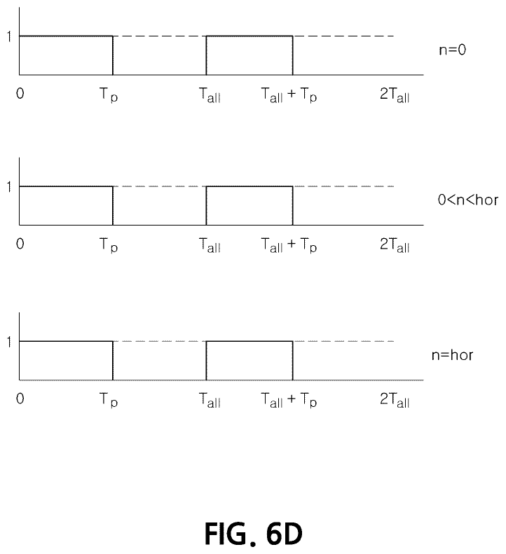

FIGS. 6A through 6D are views illustrating an on/off period of the projection pattern in the apparatus and the method for outputting a projection of a vehicle according to the embodiments of the present disclosure.

Referring to FIGS. 1A and 6A-6D, the control unit 120 may drive the projection output unit 130 to periodically repeat the switching on/off of the projection pattern. Accordingly, the visual information of the projection pattern output by the projection output unit 130 may include more scanning effects, and the projection output unit 130 may thus improve projection pattern identification efficiency around the driver or the vehicle (for example, other vehicles on the road or the pedestrian).

Referring to FIGS. 6A-6C, the control unit 120 may drive the projection output unit 130 to periodically repeat the switching on/off of each pixel in the projection pattern, and at least two pixels in the projection pattern may have at least one different switching-on period length, switching-off period length, switching-on time point, or switching-off time point. Accordingly, the projection output unit 130 may further improve the projection pattern identification efficiency around the driver or the vehicle (for example, other vehicles on the road or the pedestrian).

Referring to FIGS. 1A and 6A, an order (n) of the plurality of pixels in the projection pattern output range of the projection output unit 130 may be set from zero “0” to “hor”, and switching-on/off periods (2Tₐₗₗ) of the plurality of pixels may be the same as each other. Switching-on time points (Tₐₗₗ×Nₙ/Nₕₒᵣ) of the plurality of pixels may be different from each other, switching-off time points (Tₐₗₗ+Tₐₗₗ×Nₙ/Nₕₒᵣ) of the plurality of pixels may be different from each other, lengths of switching-on periods (Tₐₗₗ) of the plurality of pixels may be the same as each other, and lengths of switching-off periods (Tₐₗₗ) of the plurality of pixels may be the same as each other.

Referring to FIGS. 1A and 6B, the order (n) of the plurality of pixels in the projection pattern output range of the projection output unit 130 may be set from zero “0” to “hor”, and the switching-on/off periods (Tₐₗₗ+Tₚ) of the plurality of pixels may be the same as each other. The switching-on time points (Tₐₗₗ×Nₙ/Nₕₒᵣ) of the plurality of pixels may be different from each other, switching-off time points (Tₚ+Tₐₗₗ×Nₙ/Nₕₒᵣ) of the plurality of pixels may be different from each other, lengths of switching-on periods (Tₚ) of the plurality of pixels may be the same as each other, and lengths of switching-off periods (Tₐₗₗ) of the plurality of pixels may be the same as each other.

Referring to FIGS. 1A and 6C, the order (n) of the plurality of pixels in the projection pattern output range of the projection output unit 130 may be set from zero “0” to “hor”, and the switching-on/off periods (2Tₐₗₗ) of the plurality of pixels may be the same as each other. The switching-on time points (Tₐₗₗ×Nₙ/Nₕₒᵣ) of the plurality of pixels may be different from each other, switching-off time points (Tₐₗₗ+Tₚ) of the plurality of pixels may be the same as each other, lengths of switching-on periods (Tₐₗₗ+Tₚ−(Tₐₗₗ×Nₙ/Nₕₒᵣ)) of the plurality of pixels may be different from each other, and lengths of switching-off periods (2Tₐₗₗ−(Tₐₗₗ+Tₚ)) of the plurality of pixels may be different from each other.

Referring to FIGS. 1A and 6D, the order (n) of the plurality of pixels in the projection pattern output range of the projection output unit 130 may be set from zero “0” to “hor”, and the switching-on/off periods (Tₐₗₗ) of the plurality of pixels may be the same as each other. The switching-on time points (0, Tₐₗₗ) of the plurality of pixels may be the same as each other, switching-off time points (Tₚ) of the plurality of pixels may be the same as each other, lengths of switching-on periods (Tₚ) of the plurality of pixels may be the same as each other, and lengths of switching-off periods (Tₐₗₗ−Tₚ) of the plurality of pixels may be the same as each other.

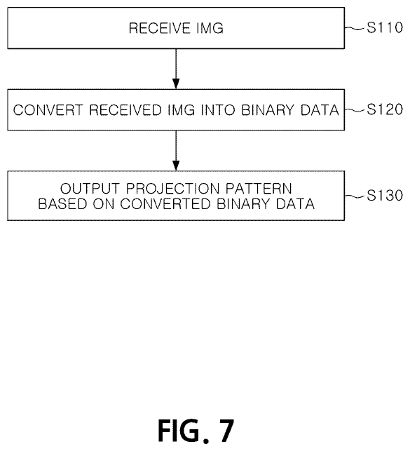

FIG. 7 is a flowchart illustrating the method for outputting a projection of a vehicle according to an embodiment of the present disclosure. Referring to FIG. 7, the method for outputting a projection of a vehicle may include: by a control unit 120 (in FIG. 1A) and/or a computing device 500 (in FIG. 1B), receiving an image IMG outside the vehicle (S110); converting the received image into binary data BIN (S120); and driving at least one of a light source and an optical system to output a projection pattern based on the converted binary data to outside the vehicle (S130). According to the method for outputting a projection of a vehicle, visual information provision performance of the projection may be improved by outputting a projection pattern that is adaptive to a structure outside the vehicle.

Referring to FIGS. 1B and 7, the computing device 500 may include the processor 501 and the storage medium 502 that records one or more programs 502a executable by the processor 501. One or more programs 502a may include instructions for executing the above-described processes (S110, S120, and S130). The storage medium 502 may record one or more programs 502a including the instructions for executing the method for outputting a projection of a vehicle.

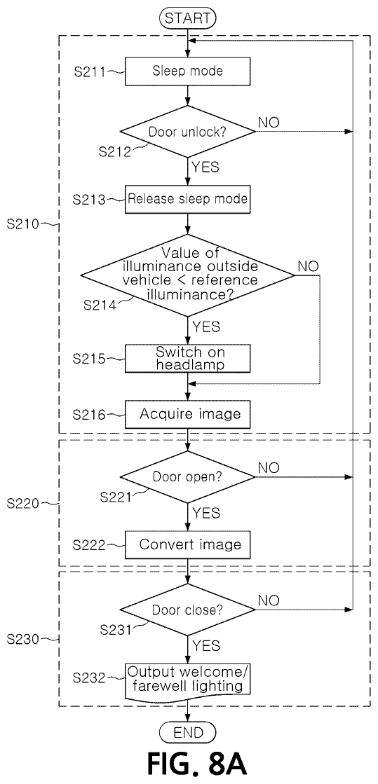

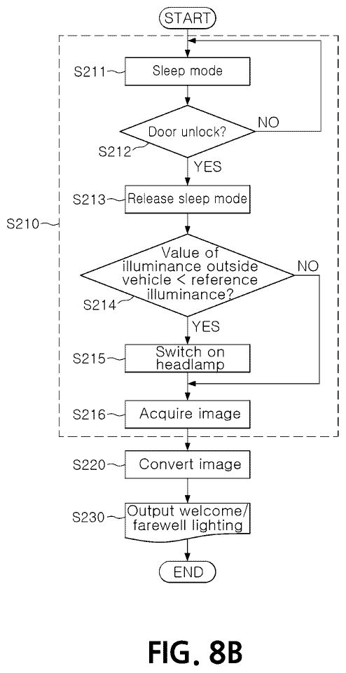

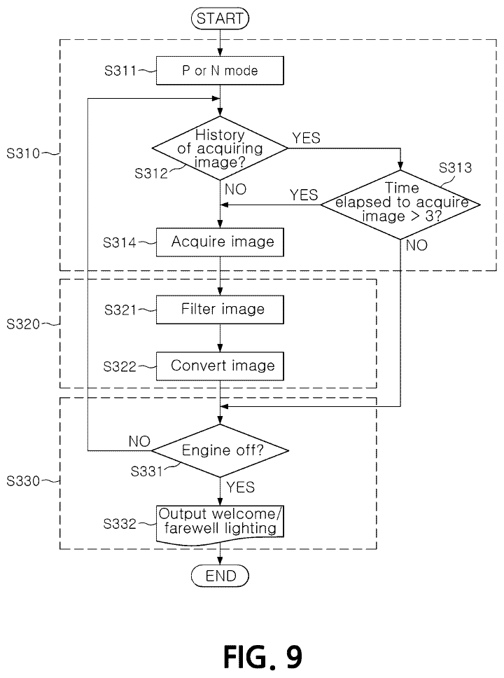

For example, the binary data may include the binary data of each of a plurality of pixels in a matrix, and in the driving (S130, S230 in FIG. 8A, S230 in FIG. 8B, or S330 in FIG. 9A), at least one of the light source and the optical system may be driven to output the projection pattern whose switching-on/off is determined in response to the binary data of each of the plurality of pixels.

For example, in the converting (S120, S220 in FIG. 8A, S220 in FIG. 8B, or S320 in FIG. 9A) an edge may be detected based on a change in a pixel value of each of the plurality of pixels of the image outside the vehicle, and the binary data may be generated based on the edge; and in the driving (S130, S230 in FIG. 8A, S230 in FIG. 8B, or S330 in FIG. 9A), at least one of the light source and the optical system may be driven to output the projection pattern in which one of the pixels corresponding to the edge and the pixels not corresponding to the edge is determined to be switched on and the other is determined to be switched off.

For example, in the receiving (S110, S210 in FIG. 8A, S210 in FIG. 8B, or S310 in FIG. 9A), the image outside the vehicle may be received in response to at least one of a change in whether a vehicle door is opened, a change in whether the door is locked, a transmission manipulation of the vehicle, and an engine starting manipulation of the vehicle, the light source of the vehicle may be controlled to be switched on when illuminance outside the vehicle is lower than reference illuminance, and the image outside the vehicle may be received after the light source is switched on when the illuminance outside the vehicle is lower than the reference illuminance.

FIGS. 8A and 8B are flowcharts illustrating that the light source is controlled based on the illuminance outside the vehicle, and the projection pattern is output in response to the change in whether the door is opened or locked, by the apparatus and the method for outputting a projection of a vehicle according to the embodiments of the present disclosure.

Referring to FIGS. 1A, 8A, and 8B, the control unit 120 may drive the projection output unit 130 (S230 or S232) to output the projection pattern in response to the change in whether the vehicle door is opened or locked (S212, S221, or S231). For example, the control unit 120 may be deactivated (or put into a state for minimizing power consumption) by being operated in a sleep mode (S211) when the vehicle door is locked, and activated by being released from the sleep mode (S213) when the door is unlocked.

The control unit 120 may then control the light source of the vehicle to be switched on (S215) when the illuminance outside the vehicle is lower than the reference illuminance (S214), and convert the image received by the image receiving unit 110 into the binary data (S216) after the light source is switched on. Accordingly, the control unit 120 may have an improved conversion accuracy and/or efficiency when converting the image into the binary data. For example, the control unit 120 may switch on the light source of the vehicle before the image receiving unit 110 receives the image if the outside of the vehicle is generally dark (e.g., at night or in a space having insufficient exterior lighting). For example, the image receiving unit 110 may receive the image without the control unit 120 switching on the light source of the vehicle if the outside of the vehicle is bright overall (e.g., at daytime or in a space having sufficient exterior lighting).

For example, the control unit 120 may generate a value of the illuminance outside the vehicle based on the image received by the image receiving unit 110, and control output intensity of the projection output unit 130 based on the illuminance outside the vehicle. For example, the control unit 120 may use the average value of the pixel values of the plurality of pixels in the image as the value of the illuminance outside the vehicle, and control the output intensity through dimming control of the projection output unit 130. For example, the control unit 120 may perform the dimming control by controlling a magnitude of power or current (or a pulse width in pulse width modulation) provided to the light source 131 in FIG. 5A or the light source 133L in FIG. 5C.

Referring to FIGS. 1A and 8A, the control unit 120 may then convert the image into the binary data (S222) when the door is opened, and output the projection pattern (S232) when the door is closed. The control unit 120 may convert the image into the binary data when the door is closed and output the projection pattern when the door is opened, based on its design. For example, the projection pattern in response to the change in whether the vehicle door is opened or locked (S212, S221, or S231) may be defined as variable (or adaptive) welcome/farewell lighting based on the structural/environmental information outside the vehicle, and may have an effect of providing the driver with the visual information of welcome or farewell.

The conversion into the binary data (S222) or the output of the projection pattern (S232) based on whether the door is opened, as shown in FIG. 8A, may be omitted in FIG. 8B, based on its design. The control unit as shown in FIG. 8B may automatically convert the image into the binary data and automatically output the projection pattern when activated by being released from the sleep mode (S213).

FIG. 9 is a flowchart illustrating that the projection pattern is output in response to the transmission manipulation and an engine starting manipulation by the apparatus and the method for outputting a projection of a vehicle according to the embodiments of the present disclosure.

Referring to FIGS. 1A and 9, the control unit 120 may drive the projection output unit 130 (S330 or S332) to output the projection pattern in response to the transmission manipulation (S311) of the vehicle and/or the engine starting manipulation (S331). For example, the control unit 120 may drive the projection output unit 130 (S330 or S332) when the transmission is manipulated to a park (P) gear or a neutral (N) gear.

The control unit 120 may then check whether there is an history of acquiring an image by the image receiving unit 110 (S312), check whether time elapsed to acquire the image is more than a specific time (e.g., 3 seconds) if there is the history of acquiring the image (S313), and control the image receiving unit 110 to selectively acquire the image based on a checked result.

The control unit 120 may then filter the image (S321), and convert the image into the binary data (S322) as shown in FIG. 3A. The control unit 120 may then check whether a vehicle engine is off (S331), and output the projection pattern if the vehicle engine is off (S332). For example, the projection pattern in response to the transmission manipulation (S311) or engine starting manipulation (S331) of the vehicle may be defined as variable (or adaptive) welcome/farewell lighting based on the structural/environmental information outside the vehicle, and may have the effect of providing the driver with the visual information of welcome or farewell.

Meanwhile, referring to FIG. 1B, the computing device 500 of the control unit 120 in the apparatus 100 for outputting a projection of a vehicle according to an embodiment of the present disclosure may include at least one processor 501, the computer-readable storage medium 502, and the communications bus 503. The communications bus 503 may interconnect various other components of the computing device 500, including the processor 501 and the computer-readable storage medium 502.

The processor 501 may cause the computing device 500 to be operated according to the exemplary embodiments described above. For example, the processor 501 may execute one or more programs stored in the computer-readable storage medium 502. One or more programs may include one or more computer-executable instructions, and the computer-executable instructions may cause the computing device 500 to perform the operations according to the exemplary embodiments, when executed by the processor 501.

The computer-readable storage medium 502 may store the computer-executable instructions or program codes, program data, and/or other suitable form of information. The program 502a stored in the computer-readable storage medium 502 may include a set of instructions executable by the processor 501. In an embodiment, the computer-readable storage medium 502 may be a memory (for example, a volatile memory such as a random access memory, a non-volatile memory, or a suitable combination thereof), at least one magnetic disk storage device, an optical disk storage device, a flash memory device, any other type of storage medium capable of being accessed by the computing device 500 and storing desired information, or a suitable combination thereof.

The computing device 500 may also include one or more input/output interfaces 505 and one or more network communications interfaces 506 that provide interfaces for one or more input/output devices 504. The input/output interface 505 and the network communications interface 506 may be connected to the communications bus 503. A network may be any of a cellular network such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), 5th generation (5G), wireless fidelity (Wi-Fi), or another cellular network, and may also be implemented as Ethernet, media oriented systems transport (MOST), Flexray, controller area network (CAN), local interconnect network (LIN), internet, Bluetooth, near field communication (NFC), Zigbee, radio frequency (RF), or the like.

The input/output device 504 may be connected to other components of the computing device 500 through the input/output interface 505. The exemplary input/output device 504 may include an input device such as a pointing device (e.g., mouse or trackpad), a keyboard, a touch input device (e.g., touchpad or touchscreen), a voice or sound input device, various types of sensor devices, and/or a capturing device, and/or an output device such as a display device, a printer, a speaker, and/or a network card. The exemplary input/output device 504 may be disposed in the computing device 500 as a component included in the computing device 500, or may be connected to the computing device 500 as a separate device distinct from the computing device 500.

According to the embodiments of the present disclosure, the apparatus and method may include a program for executing the methods described herein on a computer, and a computer-readable recording medium including the program. The computer-readable recording medium may include a program instruction, a local data file, a local data structure, or the like, either alone or in combination. The medium may be specifically designed and configured for the present disclosure, or may be commonly available in a computer software field. An example of the computer-readable recording medium may include a magnetic medium such as a hard disk, a floppy disk, or a magnetic tape, an optical recording medium such as a compact disk read only memory (CD-ROM) or a digital versatile disk (DVD), or a hardware device specifically storing and executing a program instruction such as a read only memory (ROM), a random access memory (RAM), or a flash memory. An example of the program may include a high-level language code executable by the computer using an interpreter, or the like, as well as a machine language code made by a compiler.

As set forth above, the apparatus and the method for outputting a projection of a vehicle according to the embodiments of the present disclosure may improve the visual information provision performance by outputting the projection pattern adaptive to the structure outside the vehicle.

While the embodiments have been shown and described above, it should be apparent to those having ordinary skill in the art that modifications and variations could be made without departing from the scope of the present disclosure as defined by the appended claims.

What is claimed is:

1. An apparatus for outputting a projection of a vehicle, the apparatus comprising a control unit configured to:
convert an image received by an image receiving unit of the vehicle into binary data, and
drive a projection output unit of the vehicle to output a projection pattern based on the binary data.

2. The apparatus according to claim 1, wherein:
the binary data includes binary data of each of a plurality of pixels in a matrix, and
the control unit is configured to drive the projection output unit and output the projection pattern whose switching-on/off is determined in response to the binary data of each of the plurality of pixels.

3. The apparatus according to claim 2, wherein the control unit is configured to perform pixel matching processing between the plurality of pixels in the image received by the image receiving unit and the plurality of pixels in the binary data.

4. The apparatus according to claim 2, wherein the control unit is configured to:
detect an edge based on a change in a pixel value of each of the plurality of pixels in the image received by the image receiving unit, and
generate the binary data based on the edge.

5. The apparatus according to claim 4, wherein the control unit is configured to:
remove noise from the image received by the image receiving unit,
calculate the change in the pixel value,
detect a strong edge based on the change in the pixel value,
detect edge candidates that are weaker than the strong edge,
detect a weak edge that extends from the strong edge among the weak edge candidates, and
generate the binary data based on the strong edge and the weak edge.

6. The apparatus according to claim 4, wherein the control unit is configured to:
drive the projection output unit to output the projection pattern in which one of the plurality of pixels corresponding to the edge and the pixels not corresponding to the edge is determined to be switched on and other one of the plurality of pixels is determined to be switched off.

7. The apparatus according to claim 4, wherein the control unit is configured to drive the projection output unit to output the projection pattern having the same shape as at least a portion of the edge.

8. The apparatus according to claim 2, wherein:
the projection output unit includes at least one of a light source or an optical system, and
the control unit is configured to control switching-on/off of the at least one of the light source or the optical system in response to the binary data of each of the plurality of pixels.

9. The apparatus according to claim 2, wherein the control unit is configured to drive the projection output unit to periodically repeat the switching on/off of the projection pattern.

10. The apparatus according to claim 9, wherein:
the control unit is configured to drive the projection output unit to periodically repeat the switching on/off of each pixel in the projection pattern, and
at least two pixels in the projection pattern have at least one different switching-on period length, switching-off period length, switching-on time point, or switching-off time point.

11. The apparatus according to claim 1, wherein:
the control unit is configured to control a light source of the vehicle to be switched on when illuminance outside the vehicle is lower than reference illuminance, and
convert the image received by the image receiving unit into the binary data after the light source is switched on.

12. The apparatus according to claim 11, wherein:
the projection output unit includes the light source, and
the control unit is configured to generate a value of the illuminance outside the vehicle based on the image received by the image receiving unit.

13. The apparatus according to claim 1, wherein the control unit is configured to control output intensity of the projection output unit of the vehicle based on illuminance outside the vehicle.

14. The apparatus according to claim 1, further comprising the projection output unit including at least one of a light source or an optical system,
wherein the projection output unit is disposed in the vehicle as a headlamp.

15. The apparatus according to claim 1, wherein the control unit is configured to drive the projection output unit to output the projection pattern in response to at least one of the following: a change in whether a vehicle door is opened, a change in whether the vehicle door is locked, a transmission manipulation of the vehicle, and an engine starting manipulation of the vehicle.

16. A method for outputting a projection of a vehicle, the method comprising:
receiving an image outside the vehicle;
converting the received image into binary data; and
driving at least one of a light source or an optical system to output a projection pattern based on the converted binary data outward from the vehicle.

17. The method according to claim 16, wherein:
the binary data includes binary data of each of a plurality of pixels in a matrix, and
in driving the at least one of the light source or the optical system, the at least one of the light source or the optical system is driven to output the projection pattern whose switching-on and off is determined in response to the binary data of each of the plurality of pixels.

18. The method according to claim 17, wherein in converting the received image, an edge is detected based on a change in a pixel value of each of the plurality of pixels in the image outside the vehicle, and the binary data is generated based on the edge, and
in driving the at least one of the light source or the optical system, at least one of the light source or the optical system is driven to output the projection pattern in which one of the plurality of pixels corresponding to the edge and the pixels not corresponding to the edge is determined to be switched on and another of the plurality of pixels is determined to be switched off.

19. The method according to claim 18, wherein:
in receiving the image, the image outside the vehicle is received in response to at least one of the following: a change in whether a vehicle door is opened, a change in whether the vehicle door is locked, a transmission manipulation of the vehicle, and an engine starting manipulation of the vehicle,
the light source of the vehicle is controlled to be switched on when illuminance outside the vehicle is lower than reference illuminance, and
the image outside the vehicle is received after the light source is switched on when the illuminance outside the vehicle is lower than the reference illuminance.

20. A non-transitory computer-readable medium having one or more programs including instructions recorded thereon, the one or more programs to direct a processor to perform a method for outputting a projection of a vehicle, the method comprising:
receiving an image outside the vehicle;
converting the received image into binary data; and
driving at least one of a light source or an optical system to output a projection pattern based on the converted binary data outward from the vehicle.
